(19) United States
(12) Patent Application Publication
(10) Pub. No.: US 2026/0178443 A1
(43) Pub. Date: Jun. 25, 2026

(54) MATCHING L1 WRITEBACK TO L2 INCLUSIVE CACHE WHEN WAYS HAVE ECC ISSUE

(71) Applicant: Google LLC, Mountain View, CA (US)

(72) Inventors: Sadayan Ghows Ghani Sadayan Ebramsah Mo Abdul, Austin, TX (US); Tushar P. Ringe, Austin, TX (US); Leigang Kou, Austin, TX (US)

(21) Appl. No.: 19/126,448

(22) PCT Filed: Dec. 23, 2022
(86) PCT No.: PCT/US2022/053978

§ 371 Date: May 1, 2025

(51) Int. Cl. G06F 11/10; G06F 12/0897

(52) U.S. Cl. CPC G06F 11/1064; G06F 12/0897; G06F 2212/403

(57) ABSTRACT

Methods, systems, and apparatus, including computer programs encoded on computer storage media, for matching L1 writeback to L2 inclusive cache when ways have error correction code (ECC) issues. One of the methods includes determining, by an L1 cache, that a matching way of a matching set has been designated as having an error correction code (ECC) issue. In response, the L1 cache writes the cache entry into the L2 cache at a location corresponding to the matching way to resolve the ECC issue.

### BACKGROUND

This specification is related to systems containing integrated circuit devices.

Caches are auxiliary devices that manage data traffic to memory. A cache interacts with one or more hardware devices in a system to store data retrieved from memory, or store data that is to be written to memory, or both. The hardware devices can be various components of an integrated circuit and be implemented into a system on a chip (SOC). Devices that supply read and write requests through caches, or directly to memory, will be referred to as client devices.

A cache is frequently utilized to reduce power consumption by limiting the total number of requests to main memory. Further power savings can be achieved by placing the main memory and the data pathways to main memory in a lowered power state. Due to the inverse correlation between cache usage and power consumption, maximizing cache usage leads to an overall decrease in power consumed. The power capacity of battery powered devices, e.g., mobile computing devices, can be spent more efficiently by increasing cache usage of integrated client devices. Moreover, accessing the cache is generally faster than accessing the main memory, thereby increasing the performance of the integrated client devices.

Caches are commonly organized into multiple sets having multiple ways. A cache can be divided into groups of blocks, and each group of blocks can be called a set. The memory address of a request can be used to identify a particular set in the cache. Each set contains one or more ways or degrees of associativity. Each way can also be called a line. Each way includes a data block and the valid and tag bits. For example, a two-way associative cache can have two data blocks.

Some client devices can have a hierarchy of multiple cache levels. The hierarchy of multiple cache levels can include “lower-level” caches and “higher-level” caches. For example, the lower-level caches can include a Level 1 (L1) cache, and the higher-level caches can include a Level 2 (L2) cache. The lower-level caches can have a smaller number of blocks, smaller block size, fewer blocks in a set, or a combination of these, but have very short access times. The higher-level caches, e.g., Level 2 and above, can have progressively larger number of blocks, larger block size, more blocks in a set, or a combination of these, and relatively longer access times, but are still much faster than the main memory.

Error correction codes (ECC) protect against undetected data corruption and can be used in computers when such corruption is unacceptable. Error correction code memory (ECC memory) is a type of computer data storage that uses an error correction code (ECC) to detect and correct n-bit data corruption which occurs in memory. ECC can be used in caches. The ECC issue in a cache system can be single bit ECC, two-bits ECC, three-bits ECC, or more than three bits ECC. Some systems can detect and correct the data corruption when the ECC issue is a corruption of one or two bits. The ECC correction process can take multiple cycles.

Some client devices can have an inclusive L2 cache that is configured to maintain all cache lines of an L1 cache. Sometimes, an L1 cache may need to perform a writeback to the L2 cache, e.g., writing a cache entry in the L1 cache back to the L2 cache. In an inclusive L2 cache, L1 should be able to find a dedicated cache line in the L2 cache that matches the L1 cache entry. However, if the ways of the L2 cache have ECC issues, the L1 cache may not be able to match the cache entry to one of the ways in the L2 cache.

When this happens, some systems can stop the writeback and perform ECC correction to fix the ECC issues in the L2 cache. After that, the L1 cache can try to match the cache entry again to the ECC corrected ways of the L2 cache, and can resume the writeback from L1 to L2. However, this process can be a multi-cycle operation and can be slow and time-consuming. Further, this process can require a dedicated storage to store the cache entry in the L2 cache while the ECC issue is fixed. The number of side storage entries required to temporarily store the L1 cache entry can be a relatively large number and can be limited to the number of available L2 cache lines. Therefore, extensive storage and backpressure mechanism may be required to allow adequate progress in the writeback from L1 to L2.

### SUMMARY

This specification describes techniques for matching L1 writeback to L2 inclusive cache when ways have error correction code (ECC) issues. The techniques can efficiently find a way in the L2 cache for the L1 writeback even when there is an ECC issue.

Particular embodiments of the subject matter described in this specification can be implemented so as to realize one or more of the following advantages. The cache system can speed up the L1 to L2 writeback process even when there is an ECC issue. Instead of performing an ECC correction, which can take multiple cycles, the cache system can efficiently determine a matching way of a matching set that has an ECC issue, e.g., when the ECC issue is corruption of one or more bits of the address. Therefore, the techniques speed up the L1 to L2 writeback process and reduce the number of storage elements required in the L2 to buffer any writeback that hits a way with ECC issues. Further, because the cache system can handle ECC issues in a much quicker fashion, the computing device can drop the power even more and the battery of the computing device can last longer. In some implementations, when the ECC issue is corruption of two or more bits of the address which can be unrecoverable using an ECC correction algorithm, the techniques can correct the address and resolve the ECC issue.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system.

FIG. 2 is a diagram of an existing system that handles ECC issues during L1 to L2 writeback.

FIG. 3 is a diagram of an example system that matches L1 writeback to L2 cache when ways have ECC issues.

FIG. 4 is a flowchart of an example process for matching L1 writeback to L2 cache when ways have ECC issues.

Like reference numbers and designations in the various drawings indicate like elements.

### DETAILED DESCRIPTION

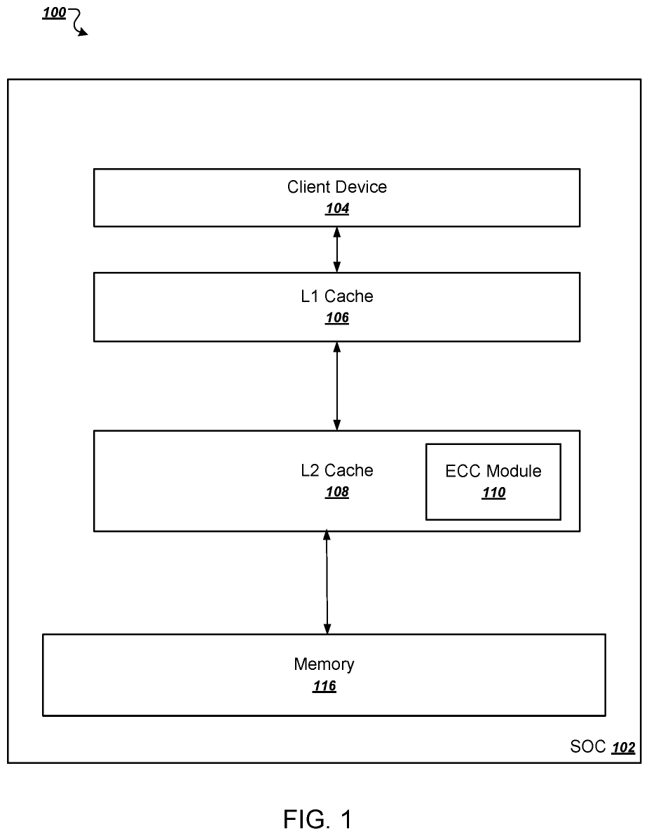

FIG. 1 is a diagram of an example system 100. The system 100 includes a client device 104 that provides memory requests for locations in a memory device 116. The client device 104 and the memory 116 can be integrated onto a single system on a chip (SOC) 102. The client device 104 or the SOC 102 itself can be a central processing unit (CPU), a graphics processing unit (GPU), a tensor processing unit (TPU), an ambient computing module, an image processor, a sensor processing module, an application-specific integrated circuit (ASIC), or other lower-level components of the SOC 102 itself that are capable of issuing memory requests to the memory 116.

The SOC 102 is an example of a device that can be installed on or integrated into any appropriate computing device, which may be referred to as a host device. Because the techniques described in this specification are particularly suited to reducing power consumption and increasing performance for the host device, the SOC 102 can be especially beneficial when installed on mobile host devices that rely on battery power, e.g., a smart phone, a smart watch or another wearable computing device, a tablet computer, or a laptop computer, to name just a few examples.

The system 100 can include one or more levels of cache that caches data requests for the client device 104 on the SOC 102. The system 100 can include a lower-level cache, e.g., the Level 1 (L1) cache 106, and a higher-level cache, e.g., the Level 2 (L2) cache 108. The lower-level caches can have a smaller number of blocks, smaller block size, fewer blocks in a set, or a combination of these, but have very short access times. The higher-level caches, e.g., Level 2 and above, can have progressively larger number of blocks, larger block size, more blocks in a set, or a combination of these, and relatively longer access times, but are still much faster than the main memory.

For example, the client device 104 can be a CPU and the CPU can have a hierarchy of multiple cache levels, e.g., the L1 cache 106 and the L2 cache 108, with different instruction-specific and data-specific caches at the L1 cache. The L1 cache is the one closer to the CPU and the L2 cache is at the next level. The cache memory can be implemented with static random-access memory (SRAM), or other types of memories.

In an inclusive L2 design, all L1 lines can be resident in the L2 cache. That is, the L2 cache can be configured to maintain all cache lines of the L1 cache and this can be guaranteed by hardware. For example, the L1 cache can include 8 cache lines and the L2 cache can include 24 cache lines. All 8 cache lines in L1 can be found in L2.

Sometimes, an L1 cache may need to perform a writeback to the L2 cache. That is, the L1 cache may need to write a cache entry having an address and a value back to the L2 cache. For example, an L1 cache can run out of capacity and may need to move a line, e.g., a cache entry, back to L2. In some examples, the L1 cache can be done with data in a cache entry and thus can write the cache entry back to L2.

In an inclusive L2 cache, L1 should be able to find a dedicated cache line in the L2 cache that matches the L1 cache entry because all L1 lines can be found in the L2 cache.

During a writeback, the L1 cache can determine a matching set to which the cache entry belongs based on the address of the cache entry. The L1 cache can find out the matching set based on matching the virtual address (VA) of the cache entry and physical address (PA) of the matching set in the L2 cache. Generally, a physical address (PA) is what is actually used to store the data in the memory 116 or on a hard disk. At any given time, a physical address in a higher-level cache should map to one way of a unique virtual address (VA) in the lower-level cache.

Because there can be multiple ways in a set, the L1 cache needs to determine a matching way of the matching set in L2. The L1 cache can compare the address of each way of the matching set to the address of the cache entry. If an address of a way of the matching set matches the address of the cache entry, the L1 cache can determine that the way is the matching way to writeback the cache entry. After determining the matching way of the matching set in L2, the L1 cache can evict the line of the cache entry in L1, e.g., deleting the line and/or setting it to invalid, and can write the line back to L2.

Table 1 illustrates an example of a matching set in an L2 cache that does not have an error correction code (ECC) issue. The L2 cache can be a four way set associative cache. Once a set has been selected, there would be four possible locations (ways) where the writeback might be stored.

TABLE 1

| | | ECC |
|---|---|---|
| Way | Address | issue |
| 3 | 24′bABCDEF | No |
| 2 | 24′bABCDEE | No |
| 1 | 24′bABCDDD | No |
| 0 | 24′bABCDCC | No |

In this example, the L1 cache receives a cache entry having an address that equals 24′bABCDEF. The L1 cache can determine a matching set, e.g., the set in Table 1, to which the cache entry belongs. For example, the L1 cache can compare the address of the cache entry and the address of set to determine the matching set. Because there are no ECC issues in this matching set, the addresses of the ways are not corrupted. The L1 cache can determine that way 3 is the matching way of the matching set because the address of way 3 matches the address of the cache entry. This writeback process can take one cycle.

Sometimes, a set of the L2 cache can have ECC issues. ECC issues can indicate that one or more bits of an address in the set can be corrupted. For example, the SOC 102 or the client device 104 can be in a power saving mode with low voltage and thus ECC issues may occur. When a set of the L2 cache has ECC issues, the L1 cache may not be able to match the cache entry to one of the ways in the set of the L2 cache.

The L2 cache can include an ECC module 110. The ECC module 110 can be configured to detect ECC issues in the L2 cache. The ECC module 110 can identify which way of a set has ECC issues. For example, the ECC module 110 can store an originally computed ECC based on the original address of a way. If one or more bits of the address are corrupted or flipped, the ECC module 110 can compute a second ECC and can determine that the second ECC no longer matches the originally computed ECC stored in the L2 cache. Therefore, the ECC module 110 can determine that the address of the way has ECC issues.

In some implementations, the ECC module 110 can fix the ECC issue through ECC correction. For example, the ECC module 110 can compare the second ECC and can go backwards and fix it using the originally computed ECC. In some implementations, when the L2 cache has a single bit ECC issue, e.g., corruption of one bit of an address, the L2 cache may fix the ECC issue. In some implementations, when the L2 cache has corruption of two or more bits of an address, the L2 cache may not be able to fix the ECC issue.

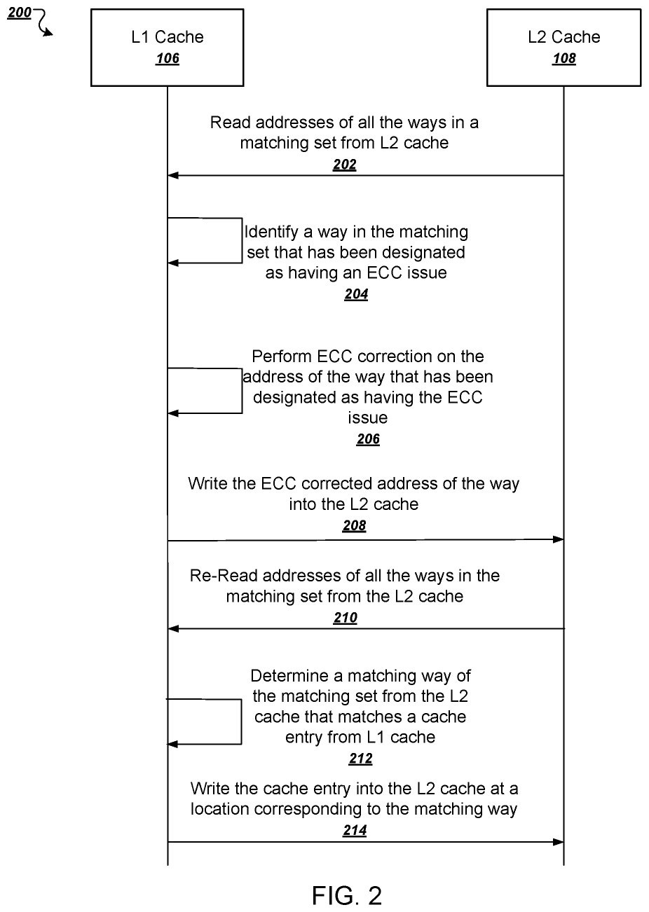

FIG. 2 is a diagram of an existing system 200 that handles ECC issues during L1 to L2 writeback. The L1 cache 106 can read addresses of all the ways in a matching set from the L2 cache 108 (202). Same as the example in Table 1, the L1 cache receives a cache entry having an address that equals 24′bABCDEF. The L1 cache can determine a matching set to which the cache entry belongs.

Table 2 illustrates an example of a matching set in an L2 cache that has a single bit ECC issue. Same as the example in Table 1, the L2 cache is a four way set associative cache. The L1 cache can determine that the matching set in Table 2 matches the address of the cache entry. The L1 cache can read all four addresses of way 0, way 1, way 2, and way 3 of the matching set.

TABLE 2

| | | ECC |
|---|---|---|
| Way | Address | issue |
| 3 | 24′bABCDEE | Yes |
| 2 | 24′bABCDEE | No |
| 1 | 24′bABCDDD | No |
| 0 | 24′bABCDCC | No |

When there are ECC issues in a matching set, the L1 cache 106 can determine that a cache entry for the writeback does not match any of the ways in the matching set. Because the ways have some address corruption, there is no correct address that matches the address of the cache entry.

The L1 cache 106 can identify a way in the matching set that has been designated as having an ECC issue (204). For example, the ECC module 110 of the L2 cache 108 can flag that way 3 has ECC issues. This is a single bit ECC issue because one bit of the original address of 24′bABCDEF is corrupted and the address of way 3 is currently 24′bABCDEE.

The L1 cache or the L2 cache can perform ECC correction on the address of the way that has been designated as having the ECC issue (206). In some implementations, the ECC module 110 can correct a single bit ECC error. For example, the ECC module can determine that the address of way 3 should be 24′bABCDEF.

The L1 cache can write the ECC corrected address of the way into the L2 cache (208). The L1 cache can re-read addresses of the ways in the matching set from the L2 cache (210). The L1 cache can determine a matching way of the matching set from the L2 cache that matches a cache entry from the L1 cache (212). For example, the L1 cache can determine that way 3 of the matching set matches the cache entry 24′bABCDEF from the L1 cache.

The L1 cache can write the cache entry into the L2 cache at a location corresponding to the matching way (214). For example, the L1 cache can write the cache entry at a location corresponding to the way 3 of the matching set in the L2 cache.

The process from 202 to 214 performed by the existing system 200 can be a multi-cycle operation. The existing system 200 needs to read the addresses of the ways, correct the ECC issues, write the corrected addresses, and perform the matching again. This could take several cycles and can make the L1 to L2 writeback process slow.

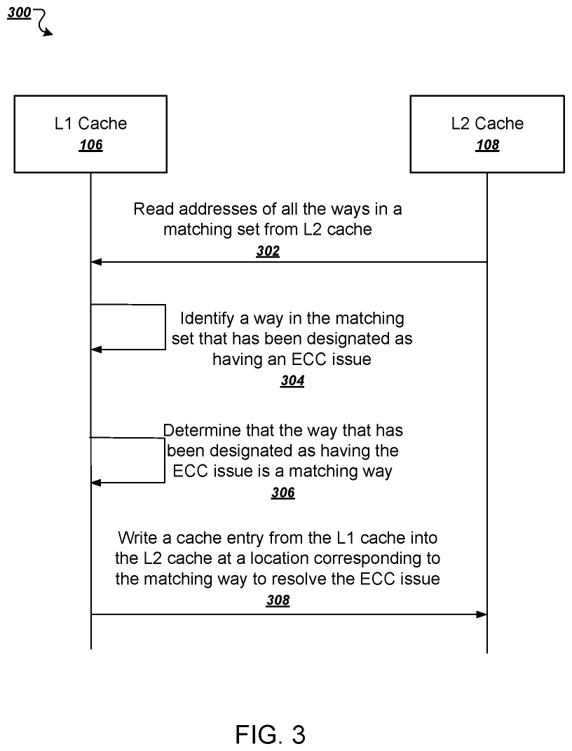

FIG. 3 is a diagram of an example system 300 that matches L1 writeback to L2 cache when ways have ECC issues. Because the L2 cache 108 is an inclusive L2 cache, a cache entry in the L1 cache 106 is guaranteed to be present (e.g., to have a matching way) in the L2 cache. If the address of the cache entry is not found in a matching set of the L2 cache and only one way of the matching set has an ECC issue, the way with the ECC issue must be the matching way.

The L1 cache can read addresses of all the ways in a matching set from the L2 cache (302). Same as the example in Table 1, the L1 cache receives a cache entry having an address that equals 24′bABCDEF. The L1 cache can determine that the matching set in Table 2 matches the address of the cache entry. The L1 cache can read all four addresses of way 0, way 1, way 2, and way 3 of the matching set.

The L1 cache can identify a way in the matching set that has been designated as having an ECC issue (304). For example, the ECC module 110 of the L2 cache can flag that way 3 has ECC issues. This is a single bit ECC issue because one bit of the original address of 24′bABCDEF is corrupted and the address of way 3 is currently 24′bABCDEE.

The L1 cache can determine that the way that has been designated as having the ECC issue is a matching way (306). Because the L2 cache is an inclusive cache, the cache entry of L1 must be in one of the ways of the matching set in L2. Because none of the addresses of way 0, way 1, and way 2 matches the address of the cache entry and way 3 has ECC issues, the L1 cache can determine that way 3 has to be the matching way, even though the address does not match. That is, the one line in the matching set that has ECC issues must be the correct destination of the writeback.

The L1 cache 106 can write a cache entry from the L1 cache into the L2 cache 108 at a location corresponding to the matching way to resolve the ECC issue (308). For example, the L1 cache can overwrite way 3 with the correct address 24′bABCDEF and with the data of the cache entry. Thus, the ECC issue in way 3 has been resolved without performing the ECC correction.

The process from 302 to 308 performed by the example system 300 can be a single cycle operation. The example system 300 does not need to correct the ECC issues, write the corrected addresses, and perform the matching again. Compared to the existing system 200, the example system 300 can determine the matching way and resolve the ECC issue in a single cycle, speeding up the L1 to L2 writeback process.

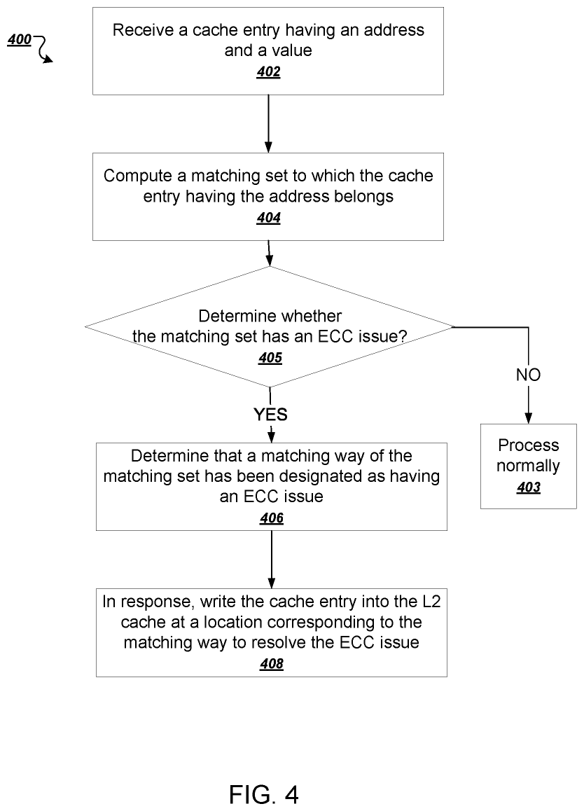

FIG. 4 is a flowchart of an example process 400 for matching L1 writeback to L2 cache when ways have ECC issues. The example process 400 can be performed by one or more components of a cache system, e.g., the example cache system 300. The example process 400 will be described as being performed by an L1 cache of a client device on an SOC, e.g., the L1 cache 106 of the client device 104 on the SOC 102, programmed appropriately in accordance with this specification.

The cache system can include an L1 cache and an inclusive L2 cache. The L2 cache can be configured to maintain all cache lines of the L1 cache.

The L1 cache receives a cache entry having an address and a value (402). Referring to Table 2, the L1 cache can receive a cache line that needs to be written back to the L2 cache. The cache entry can have an address 24′bABCDEF and a value.

The L1 cache computes a matching set to which the cache entry having the address belongs (404). The L1 cache determines whether the matching set has an ECC issue (405). If the L1 cache determines that the matching set does not have an ECC issue, the L1 cache can perform the L1 to L2 writeback normally (403), as described in the example in Table 1.

If the L1 cache determines that the matching set has an ECC issue, the L1 cache can identify the one or more ways that has an ECC issue. The L1 cache determines that a matching way of the matching set has been designated as having an error correction code (ECC) issue (406). If there is only one way with the ECC issue and none of the other ways match the cache entry, the L1 cache can determine that the one way with the ECC issue is the matching way.

For example, in Table 2, the L1 cache can determine that way 3 is the matching way of the matching set because: (1) none of the addresses of the four ways match the address of the cache entry, and (2) only one line has ECC issues.

In some implementations, the ECC issue can be corruption of one bit of the address, e.g., single bit ECC issue. In some implementations, the ECC issue can be corruption of two or more bits of the address. For example, if way 3 of Table 2 has a double bit ECC error, e.g., address of way 3 equaling 24′bABCDEC, the L1 cache can still determine that way 3 is the matching way. Thus, the cache system can not only detect two or more bits ECC issue, but also can correct two or more bits ECC issue with the techniques described in this specification.

Some existing systems cannot fix the address if there is double or more bits ECC error in the address because the address is unrecoverable. Because the way having the ECC error, no matter one bit or two bits ECC, must be the matching way, the cache system can resolve the ECC issue based on the logic described here.

In response to determining that the matching way of the matching set has been designated as having the ECC issue, the L1 cache writes the cache entry into the L2 cache at a location corresponding to the matching way to resolve the ECC issue (408).

In some implementations, the cache system can be configured to clear designation of the ECC issue after writing the cache entry into the L2 cache. For example, the ECC module 110 can flag that the ECC issue for way 3 in Table 2 has been solved after the L1 cache writes the cache entry into way 3.

If there are two or more ways with single bit ECC issues and none of the other ways match the cache entry, the L1 cache can determine that the one way with the single bit ECC issue that differs from the address of the cache entry by one bit is the matching way. In some implementations, the L1 cache can receive a second cache entry having a second address and a second value. The L1 cache can determine that two matching ways of a matching set have been designated as having an ECC issue. The L1 cache can compute respective mismatch masks for each of the two matching ways. The L1 cache can determine that a first matching way has a mismatch mask having a single set bit. In response, the L1 cache can write the second cache entry into the L2 cache at a location corresponding to the first matching way to resolve the ECC issue for the first matching way.

TABLE 3

| | | ECC | Mismatch |
|---|---|---|---|
| Way | Address | issue | Mask |
| 3 | 24′bABCDEE | Yes | 6′b000001 |
| 2 | 24′bABCDFE | Yes | 6′b000011 |
| 1 | 24′bABCDDD | No | |
| 0 | 24′bABCDCC | No | |

For example, Table 3 illustrates an example of a matching set in an L2 cache that has a single bit ECC issue. Same as the example in Table 1, the L2 cache is a four way set associative cache. The L1 cache can receive a cache entry with address 24′bABCDEF. The L1 cache can determine that none of the ways match the cache entry. The L1 cache can determine that two matching ways, e.g., way 2 and way 3, have been designated as having a single bit ECC issue.

Instead of fixing the ECC issues in way 2 and way 3, the L1 cache can compute respective mismatch masks for each of way 2 and way 3 and can determine a matching way using the mismatch masks. The L1 cache can compute the mismatch mask by comparing the address of the cache entry with the corrupted of a candidate matching way that has ECC issue.

Computing the mismatch mask does not require extra time because the L1 cache is doing the comparison anyway to figure out whether the address of a way matches the address of the cache entry. The mismatch mask can be on a per bit basis or per byte basis, depending on how much logic the cache system can afford.

For example, comparing 24′bABCDEF and 24′bABCDEE, the mismatch mask for way 3 is 6′b000001, which is a six segment mismatch vector with four bits per segment. Comparing 24′bABCDEF and 24′bABCDFE, the mismatch mask for way 2 is 6′b000011.

Any way with more than one segment mismatch, e.g., a multi-hot mismatch vector, is guaranteed to not be the matching way because the matching set is only having a single bit ECC issue and a two or more segments mismatch could only at most have one of these segments providing a false mismatch.

For example, because the matching set has a single bit ECC issue and only one bit of the address can be corrupted, the L1 cache can determine that way 2 cannot be a matching way because its mismatch mask has two set bits, e.g., two bytes mismatch. The L1 cache can determine that way 3 must be the matching way because its mismatch mask has a single set bit.

In some implementations, if after excluding all the ways with a multi-hot mismatch vector, there is only one way left, then that way is guaranteed to be the correct matching way for the L1 writeback. For example, the L1 cache can determine that way 3 must be the matching way after excluding the other three ways.

If there are two ways with single bit ECC issue and none of the other ways match the cache entry, and if both ways with single bit ECC issues differ from the address of the cache entry by one bit, the L1 cache cannot determine which way with the single bit ECC issue is the matching way and the L1 cache can perform an alternative ECC process to resolve the ECC issue. In some implementations, the L1 cache can receive a third cache entry having a third address and a third value. The L1 cache can determine that two matching ways of a matching set have been designated as having an ECC issue. The L1 cache can compute respective mismatch masks for each of the two matching ways. The L1 cache can determine that both mismatch masks have a single set bit. In response, the L1 cache can perform an alternative ECC process to resolve the ECC issue.

TABLE 4

| | | ECC | Mismatch |
|---|---|---|---|
| Way | Address | issue | Mask |
| 3 | 24′bABCDEE | Yes | 6′b000001 |
| 2 | 24′bABCDED | Yes | 6′b000001 |
| 1 | 24′bABCDDD | No | |
| 0 | 24′bABCDCC | No | |

For example, Table 4 illustrates an example of a matching set in an L2 cache that has a single bit ECC issue. Same as the example in Table 1, the L2 cache is a four way set associative cache. The L1 cache can receive a cache entry with address 24′bABCDEF. The L1 cache can determine that none of the ways match the cache entry. The L1 cache can determine that two ways, e.g., way 2 and way 3, have been designated as having a single bit ECC issue.

The L1 cache can compute respective mismatch masks for each of way 2 and way 3. For example, comparing 24′bABCDEF and 24′bABCDEE, the mismatch mask for way 3 is 6′b000001. Comparing 24′bABCDEF and 24′bABCDED, the mismatch mask for way 2 is 6′b000001. Because the mismatch masks for both way 2 and way 3 have a single set bit, the L1 cache cannot determine which one of way 2 and way 3 is the matching way.

In some implementations, the L1 cache can perform an alternative ECC process to resolve the ECC issue. For example, the L1 cache can perform ECC correct to one or both of the addresses for way 2 and way 3, and then determine which one of them is the matching way. In some implementations, the L1 cache can throw a fault and give up the writeback process. For example, the L1 cache can throw a fault and give up the writeback of the cache entry.

In some implementations, the L1 cache can receive a fourth cache entry having a fourth address and a fourth value. The L1 cache can determine that the matching set has two matching ways. The L1 cache can determine that one of the matching ways has an ECC issue and that another of the matching ways does not have an ECC issue. In response, the L1 cache can write the fourth cache entry into the L2 cache at a location corresponding to the matching way that does not have an ECC issue.

For example, Table 5 illustrates an example of a matching set in an L2 cache that has a single bit ECC issue. Same as the example in Table 1, the L2 cache is a four way set associative cache. The L1 cache can determine that the matching set in Table 2 matches the address of the cache entry. The L1 cache can read all four addresses of way 0, way 1, way 2, and way 3 of the matching set.

TABLE 5

| | | ECC |
|---|---|---|
| Way | Address | issue |
| 3 | 24′bABCDEF | No |
| 2 | 24′bABCDEF | Yes |
| 1 | 24′bABCDDD | No |
| 0 | 24′bABCDCC | No |

The L1 cache can determine that both way 3 and way 2 match the address of the cache entry. The L1 cache can determine that way 3 does not have an ECC issue and way 2 has an ECC issue. In the inclusive L2 cache, there can only be one way that matches the cache entry in L1. Thus, the L1 cache can determine that way 3 is the correct matching way and can write the cache entry into the L2 cache at a location corresponding to the way 3 that does not have an ECC issue.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a hardware-implemented or software implemented input/output system that provides an output that is different from the input. An engine can be implemented in dedicated digital circuitry or as computer-readable instructions to be executed by a computing device. Each engine can be implemented within any appropriate type of computing device, e.g., servers, mobile phones, tablet computers, notebook computers, music players, e-book readers, laptop or desktop computers, PDAs, smart phones, or other stationary or portable devices, that includes one or more processing modules and computer-readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a host device having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

In addition to the embodiments described above, the following embodiments are also innovative:

Embodiment 1 is a method performed by a cache system comprising an L1 cache and an inclusive L2 cache, the method comprising:
maintaining, by the L2 cache, cache lines of the L1 cache;
receiving, by the L1 cache, a cache entry having an address and a value;
computing, by the L1 cache, a matching set to which the cache entry having the address belongs;
determining, by the L1 cache, that a matching way of the matching set has been designated as having an error correction code (ECC) issue; and
in response, writing, by the L1 cache, the cache entry into the L2 cache at a location corresponding to the matching way to resolve the ECC issue.

Embodiment 2 is the method of embodiment 1, further comprising clearing the designation of the ECC issue after writing the cache entry into the L2 cache.

Embodiment 3 is the method of any one of embodiments 1-2, wherein the ECC issue is corruption of one bit of the address.

Embodiment 4 is the method of any one of embodiments 1-3, wherein the ECC issue is corruption of two or more bits of the address.

Embodiment 5 is the method of any one of embodiments 1-4, further comprising:
receiving a second cache entry having a second address and a second value;
determining that two matching ways of a matching set have been designated as having an ECC issue;
computing respective mismatch masks for each of the two matching ways;
determining that a first matching way has a mismatch mask having a single set bit; and
in response, writing the second cache entry into the L2 cache at a location corresponding to the first matching way to resolve the ECC issue for the first matching way.

Embodiment 6 is the method of any one of embodiments 1-5, further comprising:
receiving a third cache entry having a third address and a third value;
determining that two matching ways of a matching set have been designated as having an ECC issue;
computing respective mismatch masks for each of the two matching ways;
determining that both mismatch masks have a single set bit; and
in response, performing an alternative ECC process to resolve the ECC issue.

Embodiment 7 is the method of any one of embodiments 1-6, further comprising:
receiving a fourth cache entry having a fourth address and a fourth value;
determining that the matching set has two matching ways;
determining that one of the matching ways has an ECC issue and that another of the matching ways does not have an ECC issue; and
in response, writing the fourth cache entry into the L2 cache at a location corresponding to the matching way that does not have an ECC issue.

Embodiment 8 is a system comprising one or more integrated hardware devices that are operable to perform the method of any one of embodiments 1 to 7.

Embodiment 9 is a storage medium encoded with instructions that when executed by one or more hardware devices cause the hardware devices to perform the method of any one of embodiments 1 to 7.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A cache system comprising:
an L1 cache; and
an inclusive L2 cache that is configured to maintain all cache lines of the L1 cache,
wherein the L1 cache is configured to perform operations comprising:
receiving a cache entry having an address and a value;
computing a matching set to which the cache entry having the address belongs;
determining that a matching way of the matching set has been designated as having an error correction code (ECC) issue; and
in response, writing the cache entry into the L2 cache at a location corresponding to the matching way to resolve the ECC issue.

2. The cache system of claim 1, wherein the cache system is configured to clear the designation of the ECC issue after writing the cache entry into the L2 cache.

3. The cache system of claim 1, wherein the ECC issue is corruption of one bit of the address.

4. The cache system of claim 1, wherein the ECC issue is corruption of two or more bits of the address.

5. The cache system of claim 1, wherein the operations further comprise:
receiving a second cache entry having a second address and a second value;
determining that two matching ways of a matching set have been designated as having an ECC issue;
computing respective mismatch masks for each of the two matching ways;
determining that a first matching way has a mismatch mask having a single set bit; and
in response, writing the second cache entry into the L2 cache at a location corresponding to the first matching way to resolve the ECC issue for the first matching way.

6. The cache system of claim 1, wherein the operations further comprise:
receiving a third cache entry having a third address and a third value;
determining that two matching ways of a matching set have been designated as having an ECC issue;
computing respective mismatch masks for each of the two matching ways;
determining that both mismatch masks have a single set bit; and
in response, performing an alternative ECC process to resolve the ECC issue.

7. The cache system of claim 1, wherein the operations further comprise:
receiving a fourth cache entry having a fourth address and a fourth value;
determining that the matching set has two matching ways;
determining that one of the matching ways has an ECC issue and that another of the matching ways does not have an ECC issue; and
in response, writing the fourth cache entry into the L2 cache at a location corresponding to the matching way that does not have an ECC issue.

8. A method performed by a cache system comprising an L1 cache and an inclusive L2 cache, the method comprising:
maintaining, by the L2 cache, cache lines of the L1 cache;
receiving, by the L1 cache, a cache entry having an address and a value;
computing, by the L1 cache, a matching set to which the cache entry having the address belongs;
determining, by the L1 cache, that a matching way of the matching set has been designated as having an error correction code (ECC) issue; and
in response, writing, by the L1 cache, the cache entry into the L2 cache at a location corresponding to the matching way to resolve the ECC issue.

9. The method of claim 8, further comprising clearing the designation of the ECC issue after writing the cache entry into the L2 cache.

10. The method of claim 8, wherein the ECC issue is corruption of one bit of the address.

11. The method of claim 8, wherein the ECC issue is corruption of two or more bits of the address.

12. The method of claim 8, further comprising:
receiving a second cache entry having a second address and a second value;
determining that two matching ways of a matching set have been designated as having an ECC issue;
computing respective mismatch masks for each of the two matching ways;
determining that a first matching way has a mismatch mask having a single set bit; and
in response, writing the second cache entry into the L2 cache at a location corresponding to the first matching way to resolve the ECC issue for the first matching way.

13. The method of claim 8, further comprising:
receiving a third cache entry having a third address and a third value;
determining that two matching ways of a matching set have been designated as having an ECC issue;
computing respective mismatch masks for each of the two matching ways;
determining that both mismatch masks have a single set bit; and
in response, performing an alternative ECC process to resolve the ECC issue.

14. The method of claim 8, further comprising:
receiving a fourth cache entry having a fourth address and a fourth value;
determining that the matching set has two matching ways;
determining that one of the matching ways has an ECC issue and that another of the matching ways does not have an ECC issue; and
in response, writing the fourth cache entry into the L2 cache at a location corresponding to the matching way that does not have an ECC issue.
